(19) United States
(12) Patent Application Publication
(10) Pub. No.: US 2022/0062114 A1
(43) Pub. Date: Mar. 3, 2022

(54) Spit Receptacle Lanyard Apparatus

(71) Applicant: Rasco Davis, Cleveland, OH (US)

(72) Inventor: Rasco Davis, Cleveland, OH (US)

(21) Appl. No.: 17/011,076

(22) Filed: Sep. 3, 2020

(51) Int. Cl. A61J 19/00; A45F 5/00

(52) U.S. Cl. CPC A61J 19/00; A45F 2005/006; A45F 5/00

(57) ABSTRACT

A spit receptacle lanyard apparatus for having a convenient and sanitary spit receptacle includes a cup body having a cup bottom, a cup sidewall, and an open cup top side. A pair of attachment rings is coupled to the cup body. A lid is coupled to the cup body. The lid has a lid rim selectively engageable with the cup top side and a lid top side. The lid top side has a fixed portion and a door aperture portion. A door is coupled to the fixed portion to selectively cover or uncover the door aperture portion. A lanyard is coupled to the pair of attachment rings. The lanyard has a cord portion and a pair of attachment clips. Each attachment clip is selectively engageable with the pair of attachment rings to allow the user to wear the apparatus around his or her neck.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to spit receptacle device and more particularly pertains to a new spit receptacle device for having a convenient and sanitary spit receptacle.

### (2) Description of Related Art Including Information Disclosed Under 37 CFR 1.97 and 1.98

The prior art relates to spit receptacle devices. Known devices typically do not have a way to wear the device and instead need to be held or stored nearby. Existing devices also typically employ a lid which must be removed entirely for use rather than utilizing a hinged door.

### BRIEF SUMMARY OF THE INVENTION

An embodiment of the disclosure meets the needs presented above by generally comprising a cup body having a cup bottom, a cup sidewall, and an open cup top side. A pair of attachment rings is coupled to the cup body. A lid is coupled to the cup body. The lid has a lid rim selectively engageable with the cup top side and a lid top side. The lid top side has a fixed portion and a door aperture portion. A door is coupled to the lid. The door is coupled to the fixed portion to selectively cover or uncover the door aperture portion. A lanyard is coupled to the pair of attachment rings. The lanyard has a cord portion and a pair of attachment clips. Each attachment clip is selectively engageable with the pair of attachment rings to allow the user to wear the apparatus around his or her neck.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a spit receptacle lanyard apparatus according to an embodiment of the disclosure.

FIG. 2 is a front elevation view of an embodiment of the disclosure.

FIG. 3 is a bottom plan view of an embodiment of the disclosure.

FIG. 4 is an isometric view of an embodiment of the disclosure.

FIG. 5 is an isometric view of an embodiment of the disclosure.

FIG. 6 is a cross-sectional view of an embodiment of the disclosure along the line 6-6 of FIG. 5.

FIG. 7 is an in-use view of an embodiment of the disclosure.

### DETAILED DESCRIPTION OF THE INVENTION

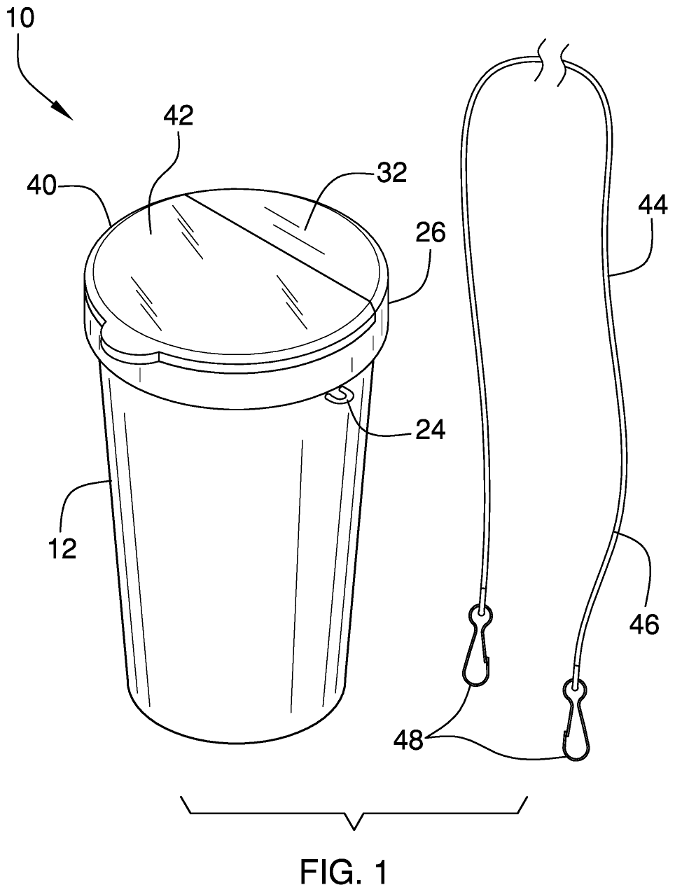

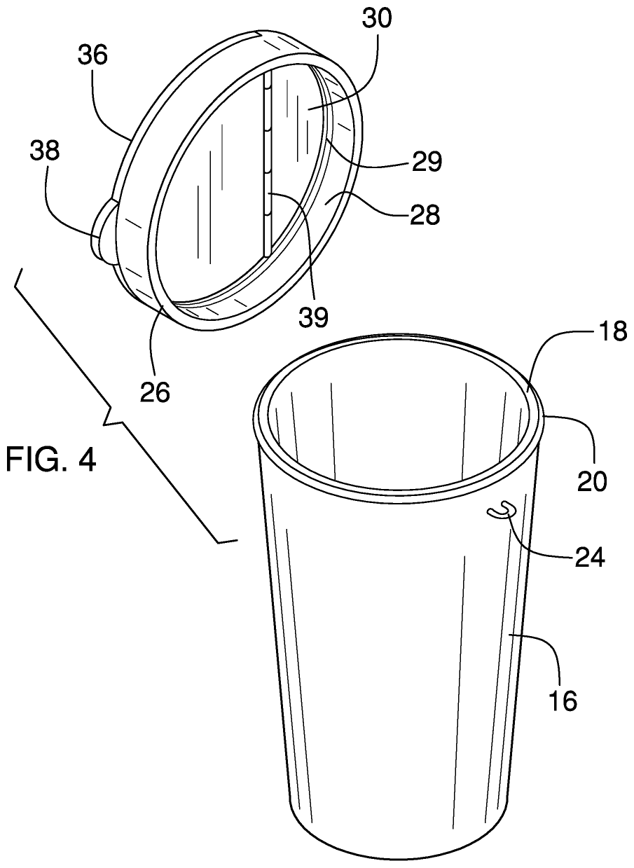

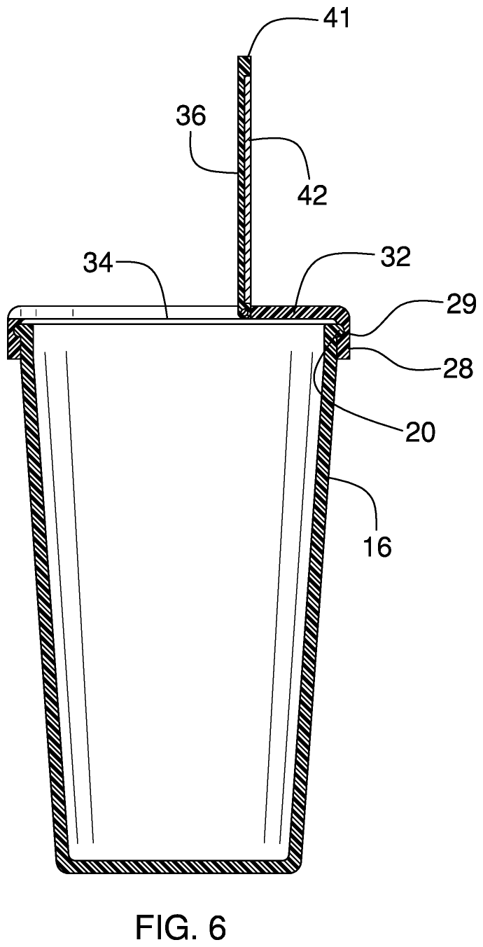

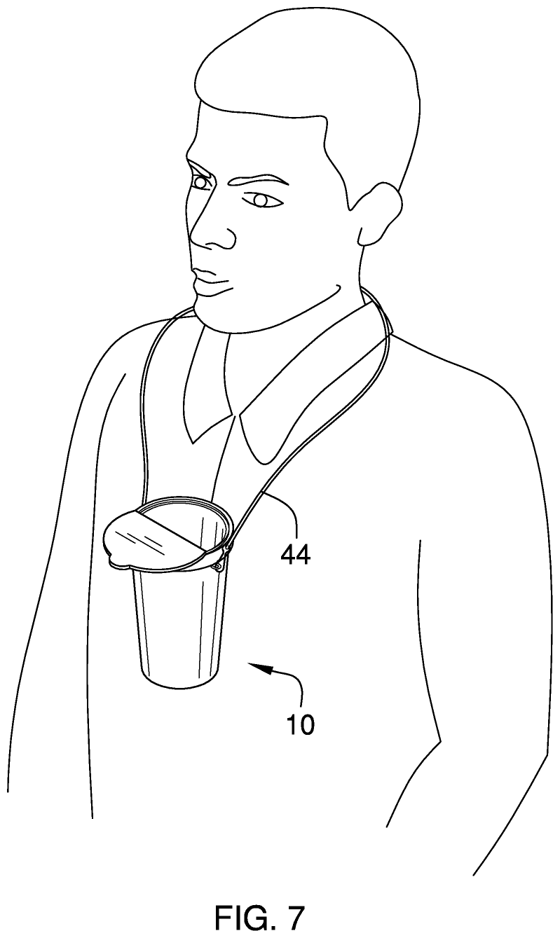

With reference now to the drawings, and in particular to FIGS. 1 through 7 thereof, a new spit receptacle device embodying the principles and concepts of an embodiment of the disclosure and generally designated by the reference numeral 10 will be described.

As best illustrated in FIGS. 1 through 7, the spit receptacle lanyard apparatus 10 generally comprises a cup body 12 having a cup bottom 14, a cup sidewall 16, and an open cup top side 18. The cup sidewall 16 may have a lip 20 adjacent the cup top side 18. The cup sidewall 16 may taper from the cup top side 18 to the cup bottom 14.

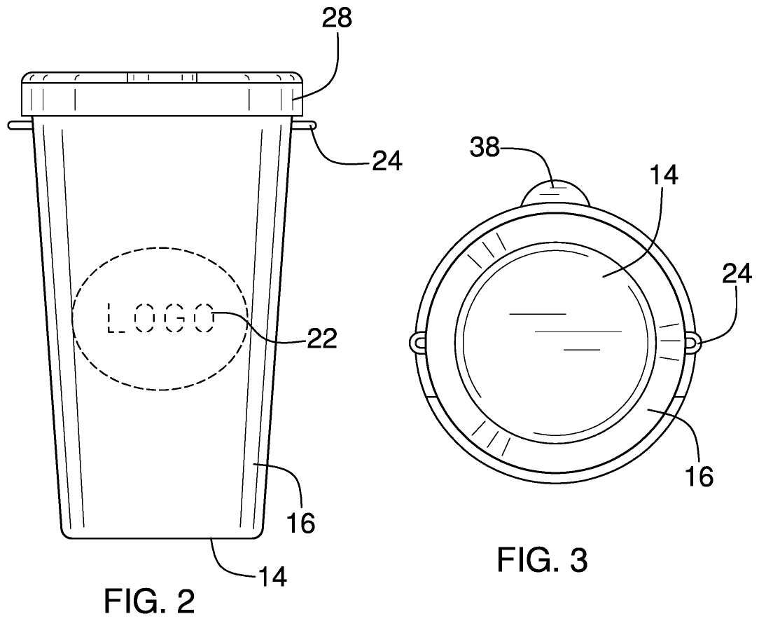

The cup body 12 may be produced in a variety of materials and colors to correspond to different sports teams or corporate sponsors. A logo 22 may be coupled to the cup body 12. The logo 22 is coupled to the cup sidewall 16 as shown in FIG. 2 to be oriented away from the user's body during use for maximum visibility.

A pair of attachment rings 24 is coupled to the cup body 12. Each attachment ring 24 is U-shaped and radially spaced 180° apart on the cup sidewall 16. The pair of attachment rings 24 is located above the midline of the cup sidewall 16 to prevent unwanted rotation of the cup body 12.

A lid 26 is coupled to the cup body 12. The lid 26 has a lid rim 28 and a lid top side 30. The lid rim 28 may have an inner channel 29 to snappingly receive the lip 20 in order to prevent unwanted separation of the lid 26 from the cup body 12. The lid top side 30 may have a fixed portion 32 and a door aperture portion 34. The fixed portion 32 may occupy less than 50% of the lid top side 30 to provide easier access to within the cup body 12.

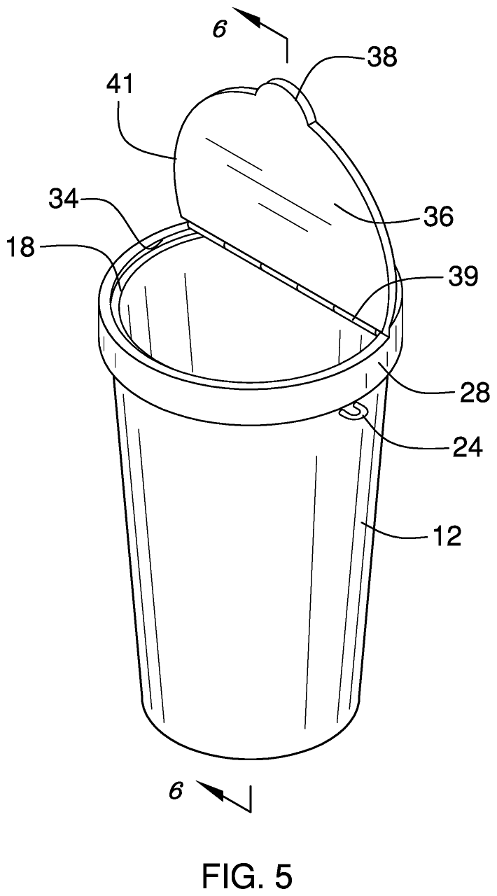

A door 36 is coupled to the lid 26. The door 36 is coupled to the fixed portion 32 to selectively cover or uncover the door aperture portion 34. The door 36 may conform to the door aperture portion 34 except for a semi-circular lift tab 38. The door 36 may have a hinge 39 to allow pivoting from a closed position 40 shown in FIG. 1 to an open position 41 shown in FIG. 5 and FIG. 7. A mirror 42 may be coupled to the door 36 in order to allow users to see if his or her teeth are clean.

A lanyard 44 coupled to the pair of attachment rings 24. The lanyard 44 has a cord portion 46 and a pair of attachment clips 48. Each attachment clip is selectively engageable with the pair of attachment rings 48 to allow the user to wear the apparatus 10 around his or her neck as shown in FIG. 7.

In use, the user wears the lanyard 44 around his or her neck to position the cup body on his or her chest. He or she may then lift the door 36 to the open position 41 in order to spit seeds, food particles, mucus, sputum, saliva, chewing tobacco, and the like into the cup body 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A spit receptacle lanyard apparatus comprising:
a cup body, the cup body having a cup bottom, a cup sidewall, and an open cup top side;
a pair of attachment rings coupled to the cup body;
a lid coupled to the cup body, the lid having a lid rim selectively engageable with the cup top side and a lid top side, the lid top side having a fixed portion and a door aperture portion;
a door coupled to the lid, the door being coupled to the fixed portion to selectively cover or uncover the door aperture portion;
a lanyard coupled to the pair of attachment rings, the lanyard having a cord portion and a pair of attachment clips, each attachment clip being selectively engageable with the pair of attachment rings to allow the user to wear the apparatus around his or her neck.

2. The spit receptacle lanyard apparatus of claim 1 further comprising each attachment ring being U-shaped and radially spaced 180° apart on the cup sidewall.

3. The spit receptacle lanyard apparatus of claim 1 further comprising the cup sidewall having a lip adjacent the cup top side, the lid rim having an inner channel to snappingly receive the lip.

4. The spit receptacle lanyard apparatus of claim 1 further comprising the door conforming to the door aperture portion except for a lift tab.

5. The spit receptacle lanyard apparatus of claim 4 further comprising the lift tab being semi-circular.

6. The spit receptacle lanyard apparatus of claim 1 further comprising a mirror coupled to the door.

7. The spit receptacle lanyard apparatus of claim 1 further comprising a logo coupled to the cup body, the logo being coupled to the cup sidewall.

8. A spit receptacle lanyard apparatus comprising:
a cup body, the cup body having a cup bottom, a cup sidewall, and an open cup top side, the cup sidewall having a lip adjacent the cup top side;
a logo coupled to the cup body, the logo being coupled to the cup sidewall;
a pair of attachment rings coupled to the cup body, each attachment ring being U-shaped and radially spaced 180° apart on the cup sidewall;
a lid coupled to the cup body, the lid having a lid rim and a lid top side, the lid rim having an inner channel to snappingly receive the lip, the lid top side having a fixed portion and a door aperture portion;
a door coupled to the lid, the door being coupled to the fixed portion to selectively cover or uncover the door aperture portion, the door conforming to the door aperture portion except for a semi-circular lift tab;
a mirror coupled to the door;
a lanyard coupled to the pair of attachment rings, the lanyard having a cord portion and a pair of attachment clips, each attachment clip being selectively engageable with the pair of attachment rings to allow the user to wear the apparatus around his or her neck.
